(19) United States
(12) Patent Application Publication
(10) Pub. No.: US 2025/0317181 A1
(43) Pub. Date: Oct. 9, 2025

(54) APPARATUS AND METHOD FOR MULTI-TEMPORAL CHANNEL STATE INFORMATION BASED MACHINE LEARNING FEEDBACK IN WIRELESS COMMUNICATION SYSTEM

(71) Applicant: ELECTRONICS AND TELECOMMUNICATIONS RESEARCH INSTITUTE, Daejeon (KR)

(72) Inventors: Anseok LEE, Daejeon (KR); Yong Jin KWON, Daejeon (KR); Seungjae BAHNG, Daejeon (KR); Youngjoon YOON, Daejeon (KR); Heesoo LEE, Daejeon (KR); Yunjoo KIM, Daejeon (KR); Hyun Seo PARK, Daejeon (KR); Jung Sook BAE, Daejeon (KR); Jungbo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 19/171,072

(22) Filed: Apr. 4, 2025

(30) Foreign Application Priority Data
Apr. 5, 2024 (KR) 10-2024-0046594
May 10, 2024 (KR) 10-2024-0061853
Mar. 24, 2025 (KR) 10-2025-0037344

(51) Int. Cl. H04B 7/06; H04L 41/16

(52) U.S. Cl. CPC H04B 7/0626; H04L 41/16

(57) ABSTRACT

The present disclosure generally relates to wireless communication systems, and more particularly to an apparatus and method for multi-temporal channel state information based machine learning feedback in wireless communication systems. A method of operating a terminal for feeding back channel state information (CSI) in a wireless communication system includes: acquiring CSI based on at least one past time instance, or at least one current time instance; deriving input CSI based on CSI for at least one past time instance and at least one current time instance; generating CSI feedback information by using the input CSI as input to a machine learning model; and transmitting the generated CSI feedback information to a base station, wherein the CSI feedback information includes prediction information for at least one target CSI at current and at least one future time instance.

### CROSS-REFERENCE TO RELATED APPLICATIONS

This application claims priority to Korean Patent Application No. 10-2024-0046594, filed on Apr. 5, 2024, Korean Patent Application No. 10-2024-0061853, filed on May 10, 2024, Korean Patent Application No. 10-2025-0037344, filed on Mar. 24, 2025 the entire contents of which are hereby incorporated by reference.

### BACKGROUND OF THE INVENTION

### Field of the Invention

The present disclosure generally relates to wireless communication systems, and more particularly to an apparatus and method for multi-temporal channel state information based machine learning feedback in wireless communication systems.

### Description of the Related Art

The International Telecommunication Union (ITU) is proceeding with the development of IMT (International Mobile Telecommunication) frameworks and standards, and is promoting 6th generation (6G) communication standardization through the “IMT for 2030 and beyond” program. Artificial intelligence (AI) is receiving attention as one of the key technologies for implementing 6G, and 3GPP has begun researching AI/ML technologies for wireless interfaces through Rel-18. The main research areas of 3GPP include:
(1) AI/ML for CSI feedback enhancement
(2) AI/ML for beam management
(3) AI/ML for positioning performance enhancement

This technology is closely related to CSI feedback performance enhancement.

In wireless communication systems, transmitters perform encoding levels of data signals, power allocation, and beamforming based on multiple transmit antennas for efficient data transmission. This requires wireless channel information between transmitters and receivers, but transmitters cannot directly observe the channel, making channel state information (CSI) reporting from receivers essential. CSI includes rank, channel quality index, and precoding information, which are used for the transmitter's data transmission scheduling.

CSI-RS (CSI-Reference Signal) is used for CSI measurement, and transmitters send this periodically or aperiodically. Transmitters configure transmission-related information in advance so receivers can receive CSI-RS. Receivers receive CSI-RS, generate CSI, and transfer it to the transmitter. However, precise channel information representation requires a large amount of information, which increases the overhead of wireless transmission resources and degrades system performance. In particular, representing channel changes for transmitter precoding decisions or precise representation of precoding information for receiver precoding vector recommendations causes significant overhead.

To address this issue, research utilizing machine learning (ML) technology is being conducted, and discussions on applying it to post-5G mobile communication systems have begun. Research using machine learning technology has proposed autoencoder-based neural networks that receive wireless channel information in image form, compress it into a low-dimensional latent space code vector through an encoder network, and restore it through a CNN (Convolutional Neural Network) based decoder. However, this approach requires transmitting the entire channel information and has issues with quantizing code vectors with real values.

For two-sided machine learning models for CSI feedback, inference is performed comprehensively by models existing on both the terminal and base station sides. The machine learning models used must operate interdependently. To satisfy this constraint, joint training, where two models are trained together at one node, is generally used.

### SUMMARY OF THE INVENTION

The present disclosure provides an apparatus and method for improving CSI feedback accuracy in wireless communication systems by utilizing one or more past CSI points.

The present disclosure also provides an apparatus and method for improving CSI reconstruction performance in wireless communication systems by utilizing past CSI feedback information.

The present disclosure also provides an apparatus and method for improving transmission efficiency in wireless communication systems by predicting current and future CSI.

The present disclosure also provides an apparatus and method for reducing transmission overhead in machine learning-based CSI feedback processes in wireless communication systems.

The present disclosure also provides an apparatus and method for efficiently performing machine learning model linkage between terminals and base stations in wireless communication systems.

According to various embodiments of the present disclosure, a method of operating a terminal for feeding back channel state information (CSI) in a wireless communication system includes: acquiring CSI for at least one past time instance or a current time instance, or only for the current time instance; deriving input CSI based on CSI for at least one past time instance or the current time instance, or only for the current time instance; generating CSI feedback information by using the input CSI as input to a machine learning model; and transmitting the generated CSI feedback information to a base station, wherein the CSI feedback information includes information about CSI for at least one past time instance or the current time instance, or information only about CSI for the current time instance.

According to various embodiments of the present disclosure, a method of operating a base station for receiving channel state information (CSI) in a wireless communication system includes: receiving CSI feedback information from a terminal; restoring current and at least one future time instance's CSI from the CSI feedback information; and monitoring prediction and compression performance of the reconstructed CSI to perform lifecycle management of a machine learning model, wherein the CSI feedback information is generated by using input CSI derived based on CSI for at least one past time instance and CSI for at least one current time instance at the terminal as input to a machine learning model.

According to various embodiments of the present disclosure, a terminal for feeding back channel state information (CSI) in a wireless communication system includes a transceiver and a controller operably connected to the transceiver, wherein the controller is configured to: acquire CSI based on CSI for at least one past time instance or a current time instance, or only for the current time instance; derive input CSI based on CSI for at least one past time instance or the current time instance, or only for the current time instance; generate CSI feedback information by using the input CSI as input to a machine learning model; and control the transmission of the generated CSI feedback information to a base station, wherein the CSI feedback information includes information about CSI for at least one past time instance or the current time instance, or information only about CSI for the current time instance.

According to various embodiments of the present disclosure, a base station for receiving channel state information (CSI) in a wireless communication system includes a transceiver and a controller operably connected to the transceiver, wherein the controller is configured to: receive CSI feedback information from a terminal; restore current and at least one future time instance's CSI from the CSI feedback information; and monitor prediction and compression performance of the reconstructed CSI to perform lifecycle management of a machine learning model, wherein the CSI feedback information is generated by using input CSI derived based on CSI for at least one past time instance and CSI for at least one current time instance at the terminal as input to a machine learning model.

### BRIEF DESCRIPTION OF THE DRAWINGS

FIG. 1 illustrates a machine learning-based CSI feedback structure using past CSI information according to an embodiment of the present disclosure.

FIG. 2 illustrates a CSI feedback procedure using past CSI information according to an embodiment of the present disclosure.

FIG. 3 illustrates a procedure for time-domain CSI feedback using aperiodic CSI-RS according to an embodiment of the present disclosure.

FIG. 4 illustrates a CSI feedback procedure using CSI feedback period according to an embodiment of the present disclosure.

FIG. 5 illustrates a CSI feedback procedure using multiple CSI feedback lengths according to an embodiment of the present disclosure.

FIG. 6 illustrates a base station's CSI reconstruction structure utilizing past CSI feedback information according to an embodiment of the present disclosure.

FIG. 7 illustrates a CSI feedback procedure utilizing past CSI feedback information according to an embodiment of the present disclosure.

FIG. 8 illustrates a CSI feedback procedure including the number of related CSI feedback information according to an embodiment of the present disclosure.

FIG. 9 illustrates a CSI feedback procedure utilizing CSI feedback delivery status according to an embodiment of the present disclosure.

FIG. 10 illustrates target CSI time instance information according to an embodiment of the present disclosure.

FIG. 11 illustrates a machine learning-based CSI feedback structure for target CSI prediction according to an embodiment of the present disclosure.

FIG. 12 illustrates a procedure for monitoring CSI compression method performance according to an embodiment of the present disclosure.

FIG. 13 illustrates a terminal-side monitoring procedure for CSI compression method performance according to an embodiment of the present disclosure.

FIG. 14 illustrates a terminal-side monitoring procedure for CSI prediction method performance according to an embodiment of the present disclosure.

FIG. 15 illustrates a base station-side monitoring procedure for CSI prediction method performance according to an embodiment of the present disclosure.

FIG. 16 illustrates a base station-side monitoring procedure for CSI prediction and compression method performance according to an embodiment of the present disclosure.

FIG. 17 illustrates a terminal-side monitoring procedure for CSI prediction and compression method performance according to an embodiment of the present disclosure.

FIG. 18 illustrates a configuration of a base station in a wireless communication system according to various embodiments of the present disclosure.

FIG. 19 illustrates a configuration of a terminal in a wireless communication system according to various embodiments of the present disclosure.

FIG. 20 illustrates a configuration of a base station in a wireless communication system according to various embodiments of the present disclosure.

FIG. 21 illustrates a configuration of a terminal in a wireless communication system according to various embodiments of the present disclosure.

### DETAILED DESCRIPTION OF THE EMBODIMENTS

Terms used in the present disclosure are used only to describe specific embodiments and are not intended to limit the scope of other embodiments. The expression of the singular form includes the expression of the plural form, unless the context clearly indicates otherwise. Technical or scientific terms used here may have the same meaning as commonly understood by those skilled in the art to which the present disclosure pertains. Terms defined in a general dictionary are to be interpreted as having the same or similar meaning in the context of the relevant art and will not be interpreted in an idealized or overly formal sense unless expressly defined herein. Even if terms are defined in this disclosure, they should not be interpreted to exclude embodiments of the present disclosure.

In the various embodiments described below, hardware approaches are exemplified. However, since the various embodiments of the present disclosure include technology using both hardware and software, the various embodiments of the present disclosure do not exclude software-based approaches.

Also, in the detailed description and claims of the present disclosure, “at least one of A, B, and C” may mean “only A”, “only B”, “only C” or “any combination of A, B, and C”. Also, “at least one of A, B, or C” or “at least one of A, B, and/or C” may mean “at least one of A, B, and C”.

The present disclosure relates to an apparatus and method for multi-temporal channel state information based machine learning feedback in wireless communication systems. Specifically, the present disclosure describes a technology to improve the compression and reconstruction accuracy of channel state information by utilizing current and past channel state information as inputs to a machine learning model in wireless communication systems, and to reduce the channel state information feedback overhead between terminals and base stations.

### Configuration 1

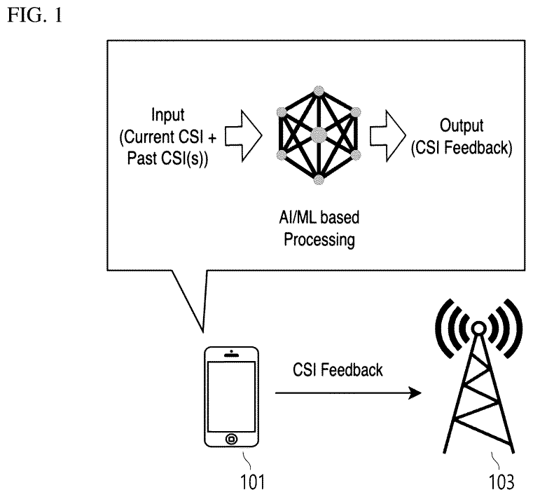

FIG. 1 illustrates a machine learning-based CSI feedback structure using past CSI information according to an embodiment of the present disclosure.

Referring to FIG. 1, a terminal (101) can use current CSI and one or more past CSIs as inputs to a machine learning model. These inputs are processed by an AI/ML-based processor and converted into CSI feedback information, which can be transmitted to a base station (103). According to one embodiment, the machine learning model can generate more accurate CSI feedback information by considering past CSI information together, utilizing temporal correlation.

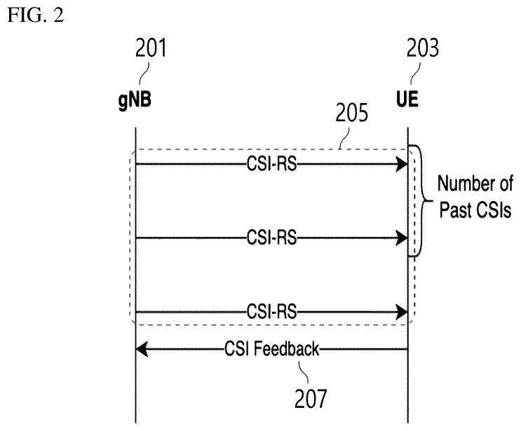

FIG. 2 illustrates a CSI feedback procedure using past CSI information according to an embodiment of the present disclosure. FIG. 2 exemplarily discloses CSI-RS, however, the present disclosure is not limited to such examples and may include any reference signal.

Referring to FIG. 2, a base station (gNB) (201) can transmit multiple CSI-RSs to a terminal (user equipment, UE) (203) (205). According to one embodiment, the number of transmitted CSI-RSs can be determined by a higher layer parameter numberOfPastCSI.

The terminal (203) can receive the configured number of CSI-RSs and measure each CSI. For example, if numberOfPastCSI is set to 2, the terminal can receive 3 CSI-RSs (2 CSI-RSs for past CSI and 1 CSI-RS for current CSI).

After collecting all necessary CSI, the terminal (203) can transmit the first CSI feedback to the base station (207).

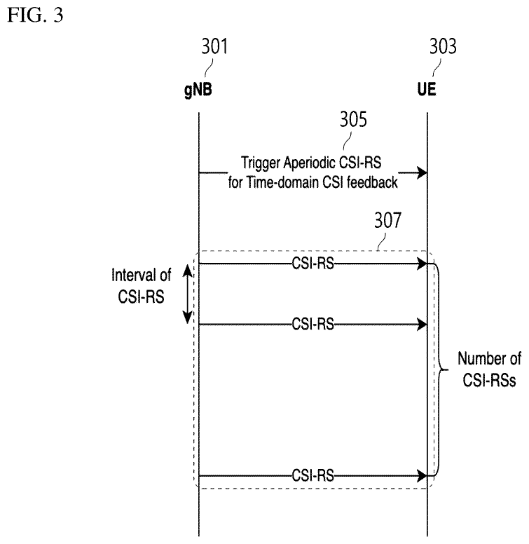

FIG. 3 illustrates a procedure for time-domain CSI feedback using aperiodic CSI-RS according to an embodiment of the present disclosure. FIG. 3 exemplarily discloses CSI-RS, however, the present disclosure is not limited to such examples and may include any reference signal.

Referring to FIG. 3, the base station (gNB) (301) transmits a trigger for aperiodic CSI-RS for time-domain CSI feedback to the terminal (UE) (303) (305). According to one embodiment, the trigger can be transmitted via lower layer signaling, for example, MAC CE (Medium Access Control Control Element) or DCI (Downlink Control Information).

After receiving the trigger, the terminal (303) can receive the CSI-RS resource designated by the base station (305) K times repeatedly (307). The time interval between each CSI-RS reception (Interval of CSI-RS) can be determined by a higher layer parameter csiInterval. Here, the K value, i.e., the number of CSI-RS repetitions, can be set in one of the following three ways:
(1) Dynamic setting through signaling for triggering
(2) Setting through higher layer parameters
(3) Fixed configuration as numberOfPastCSI+1

This aperiodic CSI-RS-based time-domain CSI feedback method enables the terminal to acquire CSI for one or more past time instances, and can be used as one of the main methods for acquiring past CSI information, along with methods using periodic or semi-persistent CSI-RS resources.

### Configuration 1-2

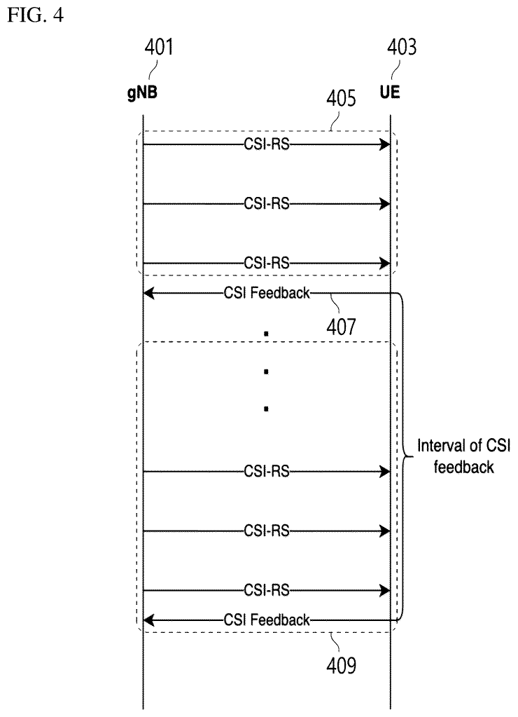

FIG. 4 illustrates a CSI feedback procedure using CSI feedback period according to an embodiment of the present disclosure. FIG. 4 exemplarily discloses CSI-RS, however, the present disclosure is not limited to such examples and may include any reference signal.

Referring to FIG. 4, the base station (gNB) (401) transmits consecutive CSI-RSs to the terminal (UE) (403) (405), and the terminal (403) can receive these CSI-RSs and perform the first CSI feedback (407). Thereafter, CSI-RS reception and CSI feedback can be repeated periodically according to the set feedback interval marked as “Interval of CSI feedback” (409).

When the terminal (403) acquires CSI for one or more past time instances, encodes CSI, and provides feedback, it can use periodic, aperiodic, or semi-persistent CSI-RS resources. The feedback period can be additionally configured from the base station (401) through a higher layer parameter, csiFeedbackInterval. According to one embodiment, the feedback operation can be determined as follows depending on the setting value of the above parameter:
(1) If csiFeedbackInterval is 1: The terminal performs CSI feedback at every CSI-RS reception time instance after the first CSI feedback
(2) If csiFeedbackInterval is 2 or more: The terminal performs CSI feedback once every csiFeedbackInterval after the first CSI feedback

This csiFeedbackInterval parameter is one of the configuration information of the machine learning model activated on the terminal side and can be transmitted to the base station as part of the model information during the model identification procedure on the terminal side.

### Configuration 1-3

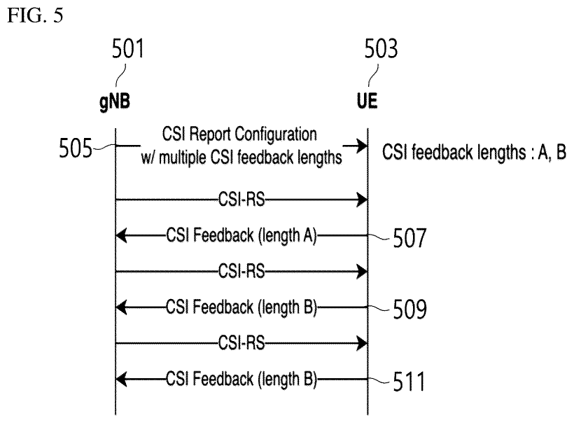

FIG. 5 illustrates a CSI feedback procedure using multiple CSI feedback lengths according to an embodiment of the present disclosure. FIG. 5 exemplarily discloses CSI-RS, however, the present disclosure is not limited to such examples and may include any reference signal.

Referring to FIG. 5, the base station (gNB) (501) first transmits CSI Report Configuration with multiple CSI feedback lengths to the terminal (UE) (503) (505). Through this, the terminal can be configured with two CSI feedback lengths (A, B).

Thereafter, when the base station transmits CSI-RS, the terminal can select one of the configured CSI feedback lengths to perform CSI feedback (507, 509, 511).

Specifically, when the terminal transmits the first CSI feedback or a certain time has elapsed since the last CSI feedback transmission, it can construct a CSI feedback message using the larger CSI feedback length (length A) (507), and in other cases, it can construct a CSI feedback message using the smaller CSI feedback length (length B) (509, 511).

Referring to FIG. 5, the first CSI feedback can be transmitted with length A, and subsequent CSI feedbacks can be transmitted with length B.

The terminal can also deliver the length of the selected CSI feedback message to the base station as additional information of the CSI feedback message. However, if the selection of CSI feedback length is made according to clear rules (longer length for the first feedback or after a certain time has elapsed, shorter length for others), the applied CSI feedback message length may not be separately delivered to the base station.

According to another embodiment, the terminal can additionally be configured with CSI time constraints from the base station. If CSI time constraints are configured, the terminal can use only the most recently received CSI-RS for current and past time instances when constructing the CSI feedback message. Especially for current time instance CSI-RS, by not using CSI-RS received after the CSI reference resource, it can selectively utilize only the CSI-RS that can most accurately reflect the channel state at each time instance.

### CSI Decoding Method Using Past CSI Feedback Information

### Configuration 2

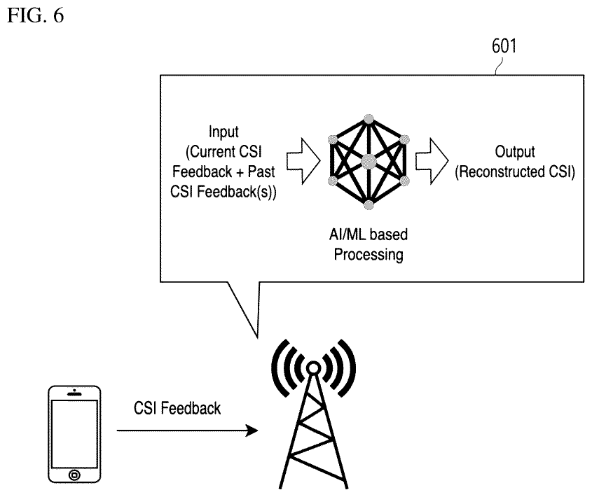

FIG. 6 illustrates a base station's CSI reconstruction structure utilizing past CSI feedback information according to an embodiment of the present disclosure.

Referring to FIG. 6, the base station's AI/ML-based processor (601) can receive current CSI feedback and past CSI feedback information as inputs, process them through a machine learning model, and generate reconstructed CSI as output. This structure can improve the reconstruction accuracy of current CSI by utilizing past CSI feedback information.

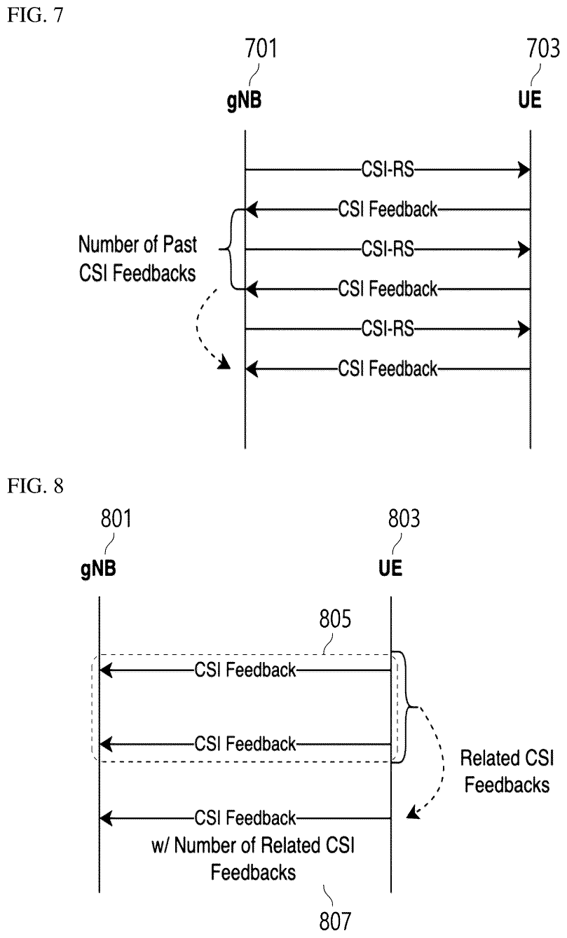

FIG. 7 illustrates a CSI feedback procedure utilizing past CSI feedback information according to an embodiment of the present disclosure.

Referring to FIG. 7, the terminal (703) can perform CSI feedback considering the maximum number of past CSI feedback information (Number of Past CSI Feedbacks) that the base station (701) can utilize.

According to one embodiment, the maximum number can be set through a higher layer parameter, maxNumberOfPastCsiFeedback, and can be delivered to the base station through higher layer signaling such as terminal capability information. The maximum number information is configuration information of the machine learning model activated on the terminal side and can be delivered to the base station as model information during the terminal-side model identification procedure.

Additionally, the terminal can configure the base station with the maximum number of past reconstructed CSI to be utilized through a higher layer parameter, maxNumberOfPastOutputCsi, so that the base station can utilize past reconstructed CSI. According to one embodiment, the maximum number of past reconstructed CSI information can be delivered to the base station through higher layer signaling such as terminal capability information.

The base station can utilize such past reconstructed CSI to restore current CSI by substituting for or using together with past CSI feedback information.

### Configuration 2-1

FIG. 8 illustrates a CSI feedback procedure including the number of related CSI feedback information according to an embodiment of the present disclosure.

Referring to FIG. 8, when transmitting CSI feedback to the base station (gNB) (801), the terminal (UE) (803) can also deliver the number of past CSI feedback information (Related CSI Feedbacks) associated with the current CSI feedback information (805). When transmitting the last CSI feedback, it includes the ‘Number of Related CSI Feedbacks’ (807), allowing the base station to know the number of past CSI feedback information to refer to when restoring CSI.

According to one embodiment, if the number of related past CSI feedback information is 0, the base station-side machine learning model can perform decoding using only the current CSI feedback information without additionally utilizing past CSI feedback information.

According to another embodiment, if the number of related past CSI feedback information is 1 or more, the base station-side machine learning model can perform decoding of CSI feedback information by additionally utilizing the specified number of past CSI feedback information.

Alternatively, the terminal can indicate the related past CSI feedback information in bitmap form. The length of this bitmap is set equal to the maximum number of available past CSI feedback information, and each bit indicates whether to utilize the past CSI feedback information at that time instance. For example, if the most significant bit (MSB) is 1, it means that the most recent past CSI feedback information was utilized in generating the current CSI feedback.

### Configuration 2-2

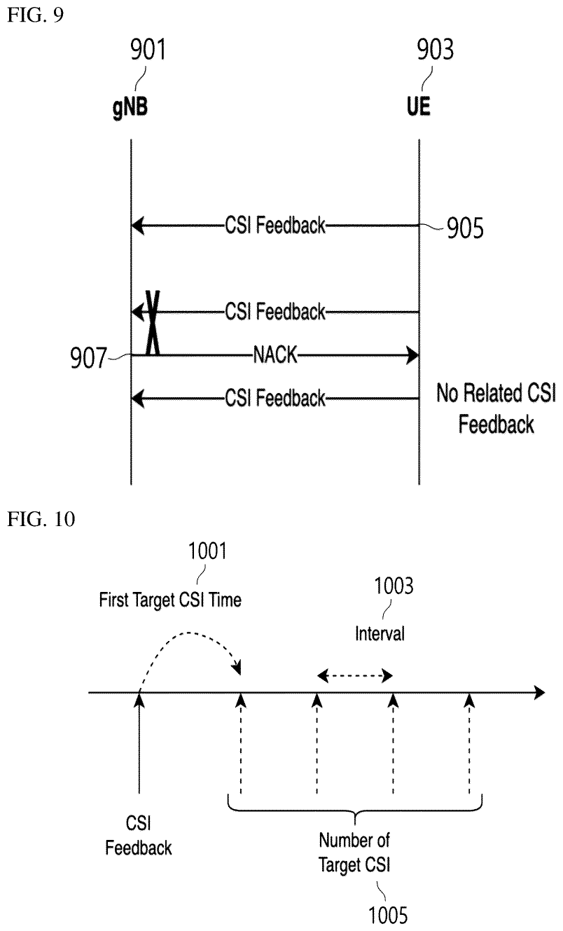

FIG. 9 illustrates a CSI feedback procedure utilizing CSI feedback delivery status according to an embodiment of the present disclosure.

Referring to FIG. 9, after the terminal (UE) (903) transmits CSI feedback to the base station (gNB) (901) (905), the base station (901) may fail to receive the second CSI feedback and transmit a NACK to the terminal (903) (907). The terminal (903) confirms through the NACK that the CSI feedback information was not delivered normally, and does not utilize past CSI feedback information when generating subsequent CSI feedback.

According to one embodiment, as indicated by “No Related CSI Feedback” in FIG. 9, the terminal (901) does not refer to the failed past CSI feedback information when generating new CSI feedback information, and can transmit by setting the number of related past CSI feedback information included in the CSI feedback information to 0.

### Configuration 2-3

According to another first embodiment, when the terminal receives the delivery status of CSI feedback information from the base station and determines that the delivery of specific CSI feedback information has failed, it does not utilize that CSI feedback information when generating subsequent CSI feedback. Particularly, when including the utilization of past CSI feedback information as a bitmap in the CSI feedback information, it can inform the base station that the information was not utilized by setting the bit position corresponding to the failed CSI feedback to 0.

### Configuration 2-4

According to another second embodiment of the present disclosure, the terminal can confirm the delivery status of CSI feedback information from the base station through the HARQ feedback procedure. For this, if the terminal utilizes past CSI feedback information, the base station can explicitly allocate or implicitly designate a HARQ process for CSI feedback transmission. The base station can transmit both ACK/NACK after receiving CSI feedback from the terminal, or transmit HARQ feedback only when a NACK occurs.

### Configuration 2-5

According to another third embodiment of the present disclosure, the terminal can receive the delivery status or delivery failure information of CSI feedback information from the base station through MAC CE (Medium Access Control Control Element) or DCI (Downlink Control Information). This provides an additional feedback method besides the HARQ feedback procedure, allowing more flexible confirmation of the delivery status of CSI feedback information.

### Configuration 2-5

According to another fourth embodiment of the present disclosure, the terminal can perform CSI feedback by receiving two or more CSI feedback lengths from the base station. When constructing a CSI feedback message, the terminal selects and uses one of the CSI feedback lengths configured from the base station, and can deliver the length information of the selected CSI feedback message to the base station as additional information in the CSI feedback message.

In particular, when the terminal receives two CSI feedback lengths from the base station, the selection of CSI feedback length is made according to the following rules. If the terminal assumes that the base station utilizes past reconstructed CSI and provides CSI feedback, it can construct a CSI feedback message by selecting the smaller length among the configured CSI feedback lengths. On the other hand, if past reconstructed CSI is not utilized, it can construct a CSI feedback message by selecting the larger CSI feedback length. If CSI feedback length is selected according to such clear rules, the selected CSI feedback message length may not be separately delivered to the base station.

### Sequential Learning Method for CSI Encoding and Decoding Methods Using Past CSI Information

### Configuration 3

The present disclosure proposes a sequential learning method for CSI encoding and decoding utilizing past CSI information, particularly a method where the terminal-side machine learning model is trained first. This terminal-side priority machine learning model training can be performed in the following sequential procedure.

First, the terminal can configure information related to its machine learning model. The configuration information can include at least one parameter among the number of past CSI (numberOfPastCSI), CSI time interval (csiInterval), minimum number of past CSI (minNumberOfPastCSI), CSI feedback interval (csiFeedbackInterval), maximum number of past CSI feedback (maxNumberOfPastCsiFeedback), or maximum number of past output CSI (maxNumberOfPastOutputCsi).

Second, the terminal can configure nominal related information for the base station-side machine learning model. This information is defined based on the previously configured terminal-side machine learning model related information, ensuring consistency between the two models.

Third, the terminal can perform learning of the two-sided machine learning model and generate a sequential learning dataset through the learned terminal-side model. Each element of this dataset can be composed of a combination including one or more input CSIs, one or more CSI feedback information, and target CSI(s). This configuration enables learning of CSI information with temporal continuity.

Finally, the terminal can deliver the previously configured terminal-side machine learning model related information and the sequential learning dataset to the base station for base station-side learning. This allows the base station to define and learn its machine learning model, resulting in efficient CSI feedback between the terminal and base station.

### Configuration 3-1

The present disclosure proposes another sequential learning method for CSI encoding and decoding utilizing past CSI information, particularly a method where the base station-side machine learning model is trained first. This base station-side priority machine learning model training can be performed in the following sequential procedure.

First, the base station can configure information related to the terminal-side machine learning model. This configuration information can include at least one parameter among the number of past CSI (numberOfPastCSI), CSI time interval (csiInterval), minimum number of past CSI (minNumberOfPastCSI), CSI feedback interval (csiFeedbackInterval), maximum number of past CSI feedback (maxNumberOfPastCsiFeedback), or maximum number of past output CSI (maxNumberOfPastOutputCsi).

This information can also be received from the terminal in advance.

Second, the base station can configure related information for its own machine learning model. This information is defined based on the previously configured terminal-side machine learning model related information, ensuring consistency between the two models.

Third, the base station can perform learning of the two-sided machine learning model and generate a sequential learning dataset through a nominal terminal-side model. Each element of this dataset can be composed of a combination including one or more input CSIs and one or more CSI feedback information.

Finally, the base station can deliver the previously configured terminal-side machine learning model related information and the sequential learning dataset to the terminal for terminal-side learning. This allows the terminal to define and learn its machine learning model, resulting in efficient CSI feedback between the terminal and base station.

### Feedback Method for Future Temporal CSI

### Configuration 4

FIG. 10 illustrates target CSI time instance information according to an embodiment of the present disclosure.

Referring to FIG. 10, the First Target CSI Time is set based on the CSI feedback time instance, and multiple target CSI time instances (Number of Target CSI(s)) are defined at the set time interval (Interval) thereafter. Based on this temporal structure, the present disclosure can propose a method to feedback target CSI(s) for current and/or future time instances in a mobile communication system consisting of a base station and one or more terminals. The terminal delivers CSI feedback information derived from the inference results of the machine learning model to the base station, where the input CSI of the terminal-side machine learning model can be past and/or current CSI or target CSI(s).

The type of input CSI can be configured as information of the terminal-side machine learning model or set through a higher layer parameter inputCsiType.

The time instance of target CSI(s) and type of input CSI can be configured as information of the terminal-side machine learning model or through higher layer settings. The time instance information of target CSI(s) consists of the time information of the first time instance of reconstruction CSI (firstTargetCsiTime) (1001), repetition count (numTargetCsi) (1003), and time interval (targetCsiInterval) (1005) information. If the number of target CSI(s) is one, repetition count and time interval information can be omitted.

### Configuration 4-1

According to another embodiment, the terminal can be configured with the time instance information of target CSI(s) and the type of input CSI from the base station through higher layer signaling. Through this, the base station can directly control the time instance and type of CSI information needed according to the network situation, and the terminal can perform CSI feedback according to this configuration.

### Configuration 4-2

According to yet another embodiment, the terminal can first report model related information including the time instance information of target CSI(s) and the type of input CSI to the base station. The base station then activates a specific model based on this information, and the terminal can perform CSI feedback by applying the time instance information of target CSI(s) and the type of input CSI corresponding to the activated model. This approach allows optimized CSI feedback considering both the capabilities of the terminal and network requirements.

### Configuration 4-3

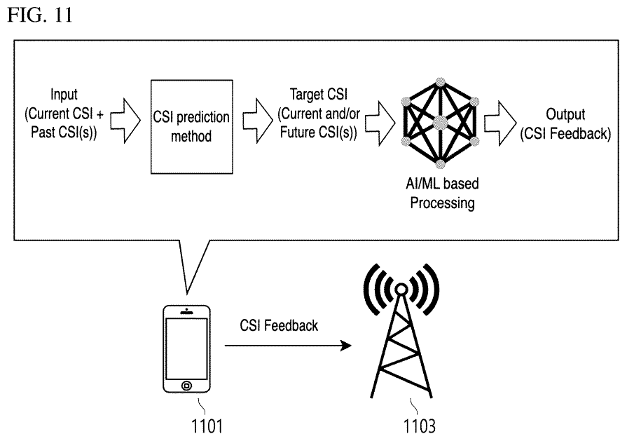

FIG. 11 illustrates a machine learning-based CSI feedback structure for target CSI prediction according to an embodiment of the present disclosure.

Referring to FIG. 11, the terminal (1101) can derive target CSI(s) through a CSI prediction method using current CSI and past CSIs as inputs (Input). The derived target CSI(s) is converted into final CSI feedback (Output) through AI/ML-based processing and transmitted to the base station (1103). In particular, if the input CSI is target CSI(s), the prediction method to derive target CSI(s) can be configured independently from the AI/ML-based processor. This separates the two processes of CSI prediction and CSI feedback generation, allowing each to be optimized. A separately learned terminal-side machine learning model can be used as the prediction method, which can have a structure specialized for time series data processing.

Alternatively, an auto-regressive model based on statistical methods can be applied instead of a machine learning model to predict channel changes over time. Through this flexible structure, the terminal can perform CSI feedback by more accurately predicting current and future channel states.

### Configuration 4-4

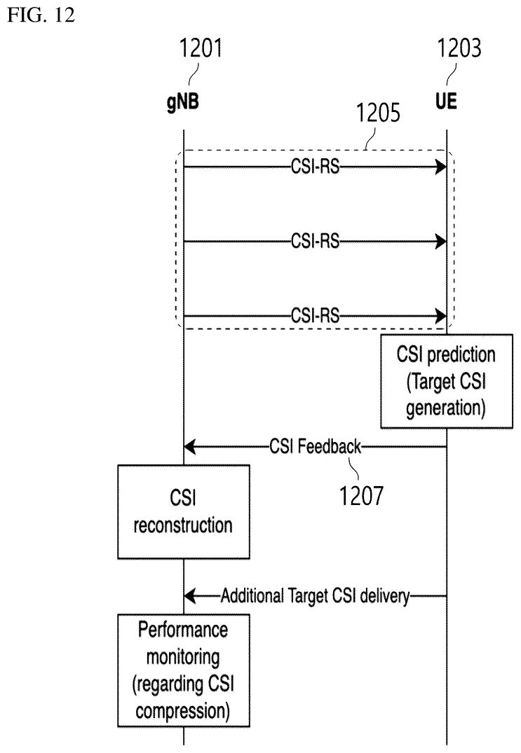

FIG. 12 illustrates a procedure for monitoring CSI compression method performance according to an embodiment of the present disclosure. FIG. 12 exemplarily discloses CSI-RS, however, the present disclosure is not limited to such examples and may include any reference signal.

Referring to FIG. 12, the base station (gNB) (1201) transmits consecutive CSI-RS to the terminal (UE) (1203) (1205), and the terminal (1203) can receive this and generate target CSI(s) through CSI prediction. The terminal (1203) transmits the generated CSI feedback information to the base station (1207), and if the input CSI is target CSI(s), it can additionally deliver the input CSI to the base station (Additional Target CSI delivery). This additional delivery can be performed in two ways: directly delivering the original CSI without compression, or using an existing CSI feedback method. When using the existing CSI feedback method, it can use a high CSI parameter combination (paramCombination) defined in the specification or even a parameter larger than the largest CSI parameter combination defined in the specification.

The base station (1201) restores the received CSI feedback information (CSI reconstruction) and can monitor the CSI compression performance (Performance monitoring) by comparing it with the input CSI additionally delivered. Based on this performance monitoring result, the base station (1201) can perform various lifecycle management actions on the machine learning model. Specifically, it can decide and execute model activation, deactivation, updates, model changes, or fallback operations.

### Configuration 4-5

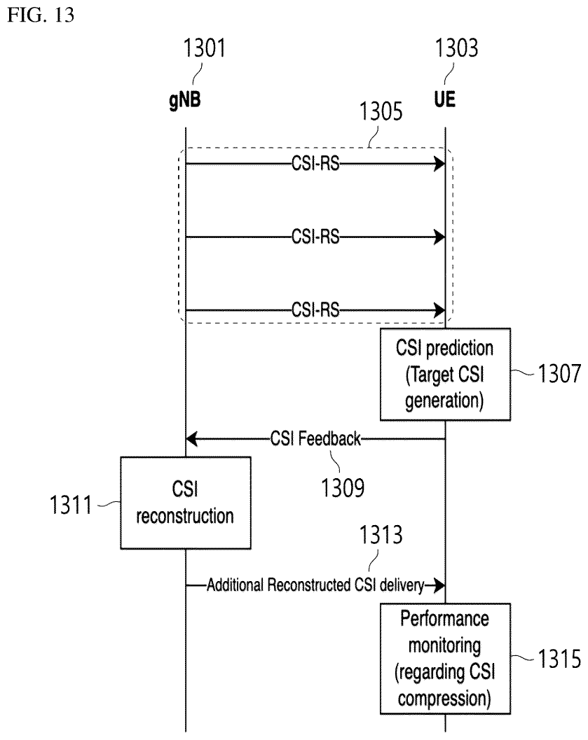

FIG. 13 illustrates a terminal-side monitoring procedure for CSI compression method performance according to an embodiment of the present disclosure. FIG. 13 exemplarily discloses CSI-RS, however, the present disclosure is not limited to such examples and may include any reference signal.

Referring to FIG. 13, the base station (gNB) (1301) transmits consecutive CSI-RS to the terminal (UE) (1303) (1305), and the terminal can receive this and generate target CSI(s) through CSI prediction (1307). The terminal transmits the generated CSI feedback information to the base station (1309), and the base station restores it (CSI reconstruction) (1311) and then delivers the reconstructed CSI back to the terminal (1313) (Additional Reconstructed CSI delivery).

According to one embodiment, if the input CSI is target CSI(s), the base station can deliver the output CSI reconstructed for each target time instance to the terminal.

The base station's output CSI delivery method is divided into two: direct delivery without compression or using an existing CSI feedback method. When using the existing CSI feedback method, it can use a high CSI parameter combination (paramCombination) defined in the specification or a parameter larger than the largest CSI parameter combination defined in the specification.

The terminal can measure and monitor the performance of the CSI compression method (1315) (Performance monitoring regarding CSI compression) based on the received reconstructed CSI. The terminal can deliver this measured performance or performance monitoring result to the base station, and the base station can perform lifecycle management actions on the machine learning model based on this information. According to one embodiment, lifecycle management actions can include model activation, deactivation, updates, model changes, or fallback operations.

### Configuration 4-6

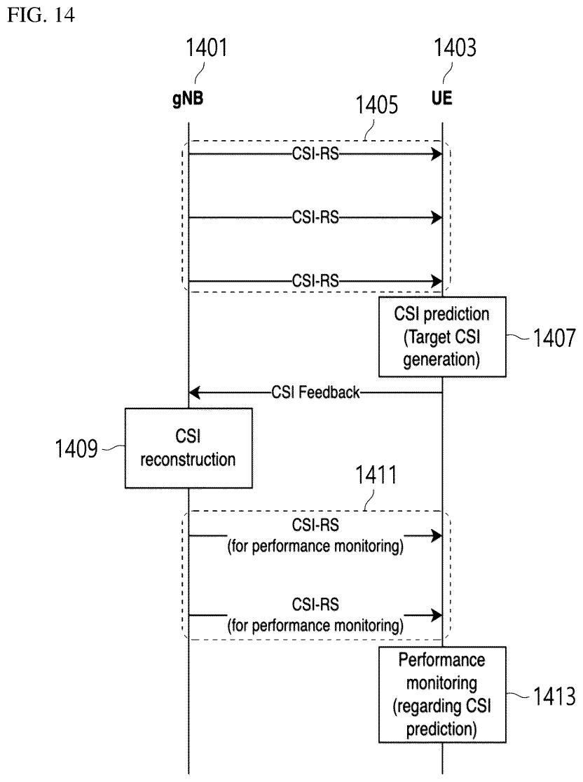

FIG. 14 illustrates a terminal-side monitoring procedure for CSI prediction method performance according to an embodiment of the present disclosure. FIG. 14 exemplarily discloses CSI-RS, however, the present disclosure is not limited to such examples and may include any reference signal.

Referring to FIG. 14, the base station (gNB) (1401) transmits consecutive CSI-RS to the terminal (UE) (1403) (1405), and the terminal (1401) can receive this and generate target CSI(s) through CSI prediction (1407). The CSI feedback information generated by the terminal (1401) is transmitted to the base station (1403) and reconstructed (CSI reconstruction) (1409). In particular, if the input CSI is target CSI(s), the base station can additionally transmit CSI-RS (for performance monitoring) at the time instance of each target CSI(s) (1411) so that the terminal can measure prediction performance.

Through this additional CSI-RS, the terminal can measure the actual channel state at each target CSI time instance, compare it with its predicted CSI, and monitor the performance of the CSI prediction method (Performance monitoring regarding CSI prediction) (1413).

The terminal can deliver the measured performance or performance monitoring result to the base station, and the base station can perform lifecycle management actions on the terminal-side prediction method based on this information. Here, lifecycle management actions can include activation, deactivation, updates, model changes, or fallback operations of the prediction method.

### Configuration 4-7

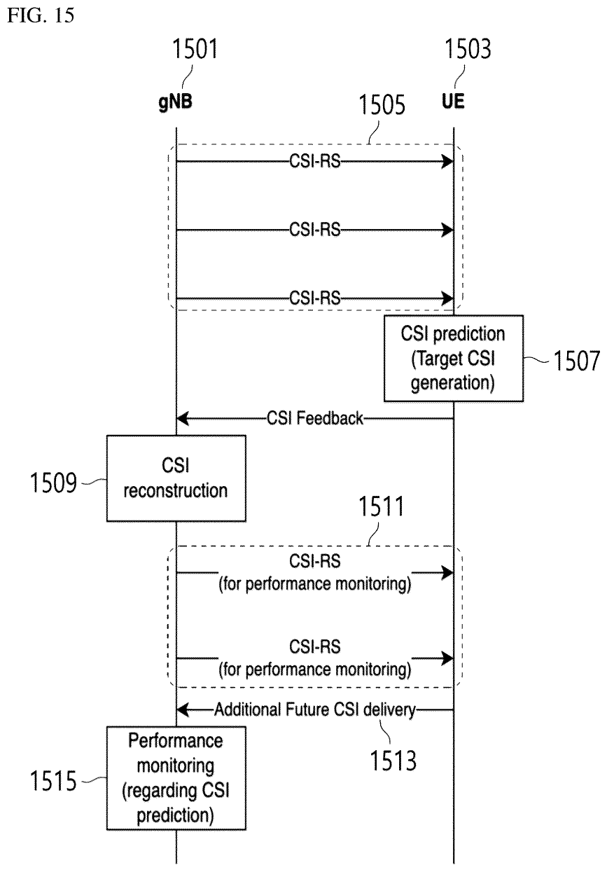

FIG. 15 illustrates a base station-side monitoring procedure for CSI prediction method performance according to an embodiment of the present disclosure. FIG. 15 exemplarily discloses CSI-RS, however, the present disclosure is not limited to such examples and may include any reference signal.

Referring to FIG. 15, the base station (gNB) (1501) transmits consecutive CSI-RS to the terminal (UE) (1503) (1505), and the terminal (1503) can receive this and generate target CSI(s) through CSI prediction (1507). The CSI feedback information generated by the terminal (1503) is transmitted to the base station (1501) and reconstructed (CSI reconstruction) (1509). Thereafter, the base station (1501) transmits CSI-RS (for performance monitoring) at the time instance of each target CSI(s) (1511), and the terminal can measure the actual channel state through this. The terminal (1503) can deliver the measured CSI to the base station through Additional Future CSI delivery (1513).

When the terminal (1503) delivers CSI at the target CSI time instance, it can use two methods. The first is to directly deliver the CSI without compression, and the second is to use an existing CSI feedback method. When using the existing CSI feedback method, it can use a high CSI parameter combination (paramCombination) defined in the specification or a parameter larger than the largest CSI parameter combination defined in the specification.

The base station (1501) compares the received actual CSI with the predicted CSI to monitor the performance of the CSI prediction method (Performance monitoring regarding CSI prediction) (1515) and performs lifecycle management actions on the terminal-side prediction method based on this. According to one embodiment, lifecycle management actions can include activation, deactivation, updates, model changes, or fallback operations of the prediction method.

### Configuration 4-8

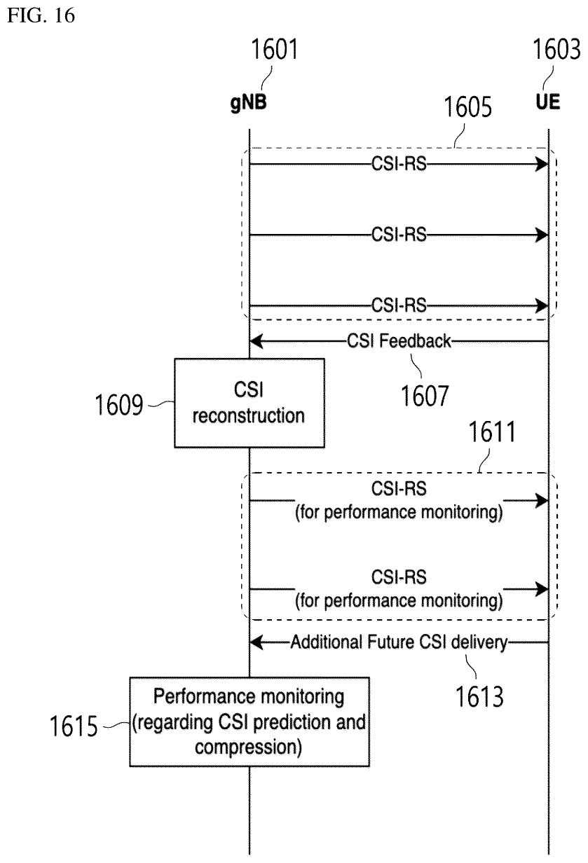

FIG. 16 illustrates a base station-side monitoring procedure for CSI prediction and compression method performance according to an embodiment of the present disclosure. FIG. 16 exemplarily discloses CSI-RS, however, the present disclosure is not limited to such examples and may include any reference signal.

Referring to FIG. 16, the base station (gNB) (1601) transmits consecutive CSI-RS to the terminal (UE) (1603) (1605), and the terminal (1603) can perform CSI feedback (1607). According to one embodiment, in operation (1607), the input CSI can be current and/or past CSI. The base station restores the received CSI feedback information (CSI reconstruction) (1609) and then can transmit CSI-RS (for performance monitoring) at the time instance of each target CSI(s) (1611). The terminal receives this to measure the actual channel state and can deliver the measured CSI to the base station through Additional Future CSI delivery (1613).

When the terminal delivers CSI at the target CSI time instance, it can use two methods. The first is to directly deliver the CSI without compression, and the second is to use an existing CSI feedback method. When using the existing CSI feedback method, it can use a high CSI parameter combination (paramCombination) defined in the specification or a parameter larger than the largest CSI parameter combination defined in the specification.

The base station compares the received actual CSI with the predicted and compressed CSI to monitor the comprehensive performance (Performance monitoring regarding CSI prediction and compression) (1615) and can perform lifecycle management actions on the machine learning model based on this. Here, lifecycle management actions can include model activation, deactivation, updates, model changes, or fallback operations.

### Configuration 4-9

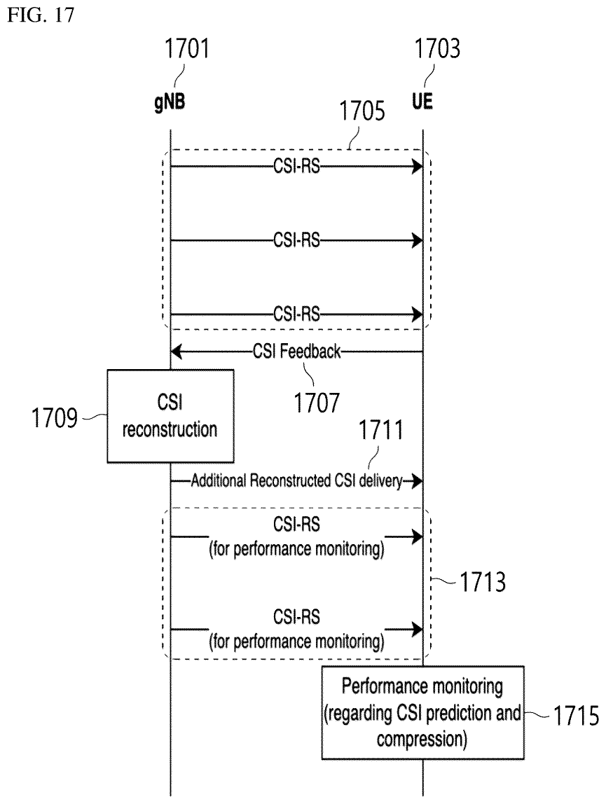

FIG. 17 illustrates a terminal-side monitoring procedure for CSI prediction and compression method performance according to an embodiment of the present disclosure.

Referring to FIG. 17, the base station (gNB) (1701) transmits consecutive CSI-RS to the terminal (UE) (1703) (1705), and the terminal (1703) can perform CSI feedback (1707). At this time, the input CSI can be current and/or past CSI. The base station (1701) restores the received CSI feedback information (CSI reconstruction) (1709) and then can deliver the output information of each reconstructed target CSI(s) to the terminal (1711) (Additional Reconstructed CSI delivery). Additionally, the base station (1701) can transmit CSI-RS (for performance monitoring) at the time instance of each target CSI(s) (1713).

When the base station delivers output CSI, it can use two methods. The first is to directly deliver the CSI without compression, and the second is to use an existing CSI feedback method. When using the existing CSI feedback method, it can use a high CSI parameter combination (paramCombination) defined in the specification or a parameter larger than the largest CSI parameter combination defined in the specification.

The terminal (1703) can compare the received reconstructed CSI with the actually measured CSI to monitor the performance of the CSI prediction and compression method (Performance monitoring regarding CSI prediction and compression) (1715). The terminal can deliver this performance measurement result to the base station, and the base station can perform lifecycle management actions on the machine learning model based on this. Here, lifecycle management actions can include model activation, deactivation, updates, model changes, or fallback operations.

### Sequential Learning Method for CSI Encoder and Decoder Machine Learning Models for Future Temporal CSI Feedback

### Configuration 5

The present disclosure proposes a terminal-side priority machine learning model training method among sequential learning methods for two-sided machine learning models for future temporal CSI feedback. This method is applied to the process of feeding back target CSI(s) for one or more future time instances in a mobile communication system consisting of a base station and one or more terminals, and is performed in the following sequential procedure.

First, the base station can configure information related to the terminal-side machine learning model. This configuration information can include one or more of the time instance information of target CSI(s) and the type of input CSI, and such information can also be received from the terminal in advance.

Second, the base station can configure related information for its own machine learning model. At this time, the base station-side machine learning model related information is defined based on the previously configured terminal-side machine learning model related information, ensuring consistency between the two models.

Third, the base station can perform learning of the two-sided machine learning model and generate a sequential learning dataset through a nominal terminal-side model. Each element of this dataset can be composed of a combination including one or more input CSIs, CSI feedback information, and one or more target CSIs. However, if the type of input CSI in the terminal-side machine learning model related information is the same as the target CSI(s), the target CSI(s) can be omitted.

Finally, the base station can deliver the previously configured terminal-side machine learning model related information and the sequential learning dataset to the terminal for terminal-side learning. This allows the terminal to define and learn its machine learning model, resulting in efficient feedback of CSI for future time instances.

### Configuration 5-1

The present disclosure proposes a base station-side priority machine learning model training method among sequential learning methods for two-sided machine learning models for future temporal CSI feedback. This method is applied to the process of feeding back target CSI(s) for one or more future time instances in a mobile communication system consisting of a base station and one or more terminals, and is performed in the following sequential procedure.

First, the terminal can configure information related to its machine learning model. This configuration information can include one or more of the time instance information of target CSI(s) and the type of input CSI.

Second, the terminal can configure related information for a nominal base station-side machine learning model. At this time, the base station-side machine learning model related information is defined based on the previously configured terminal-side machine learning model related information, ensuring consistency between the two models.

Third, the terminal can perform learning of the two-sided machine learning model and generate a sequential learning dataset through the learned terminal-side model. Each element of the sequential learning dataset can be composed of a combination including one or more input CSIs, CSI feedback information, and one or more target CSIs. However, if the type of input CSI in the terminal-side machine learning model related information is the same as the target CSI(s), the target CSI(s) can be omitted.

Finally, the terminal can deliver the terminal-side machine learning model related information and the sequential learning dataset to the base station for base station-side learning. This allows the base station to define and learn its machine learning model, resulting in efficient feedback of CSI for future time instances.

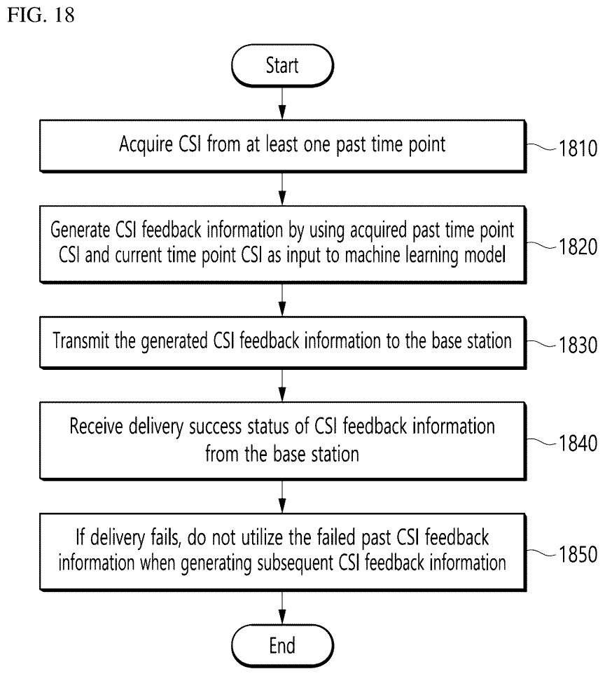

FIG. 18 illustrates a method of operation of a terminal according to an embodiment of the present disclosure.

Referring to FIG. 18, the terminal first acquires CSI for at least one past time instance (1810). According to one embodiment, CSI acquisition can use periodic, aperiodic, or semi-persistent CSI-RS resources. The terminal can additionally be configured with CSI time constraints from the base station, and if CSI time constraints are configured, it can use only the most recently received CSI-RS for CSI at current and past time instances. According to one embodiment, for current time instance CSI-RS, CSI-RS received after the CSI reference resource is not used.

When using aperiodic CSI-RS resources, the terminal receives an aperiodic CSI report request from the base station and accordingly can receive the designated CSI-RS resource K times repeatedly. Here, the K value can be dynamically set through trigger signaling, set through higher layer parameters, or fixed configuration as the number of past CSI (numberOfPastCSI)+1.

Next, the terminal can generate CSI feedback information by using the acquired past time instance CSI and current time instance CSI as inputs to the machine learning model (1820). According to one embodiment, the generated CSI feedback information can include prediction information for target CSI(s) at current and future time instances. The time instance information of target CSI(s) can include first target CSI time instance (firstTargetCsiTime), target CSI repetition count (numTargetCsi), and target CSI time interval (targetCsiInterval) information.

The terminal can be configured with two or more CSI feedback lengths from the base station and can select and use one of these when constructing the CSI feedback message. For example, if the base station utilizes past reconstructed CSI, it can select the smaller length among the configured CSI feedback lengths, and if not, it can select the larger CSI feedback length. The selected CSI feedback message length can be included as additional information in the CSI feedback message.

Then the terminal can transmit the generated CSI feedback information to the base station (1830). CSI feedback can be performed according to the set feedback period, and the CSI feedback period can be set through a higher layer parameter, CSI feedback interval (csiFeedbackInterval).

The terminal can receive the delivery success status of CSI feedback information from the base station (1840). The delivery success status can be received through Hybrid Automatic Repeat reQuest (HARQ) feedback, Medium Access Control Control Element (MAC CE), or Downlink Control Information (DCI).

If the delivery fails, the terminal does not utilie the failed past CSI feedback information when generating subsequent CSI feedback information (1850). According to one embodiment, the terminal can transmit by setting the number of past CSI feedback information related to the CSI feedback information to 0, or by setting the bit position of the failed CSI feedback in the bitmap indicating the utilization of past CSI feedback information to 0.

The terminal can receive CSI-RS for performance monitoring from the base station to measure the actual channel state, and can deliver the measured performance monitoring result to the base station. Also, it can receive output information of each reconstructed target CSI(s) from the base station and monitor CSI prediction and compression performance by comparing it with the actually measured CSI. These performance monitoring results can be delivered to the base station and used for lifecycle management of the machine learning model, such as model activation, deactivation, updates, model changes, or fallback operations.

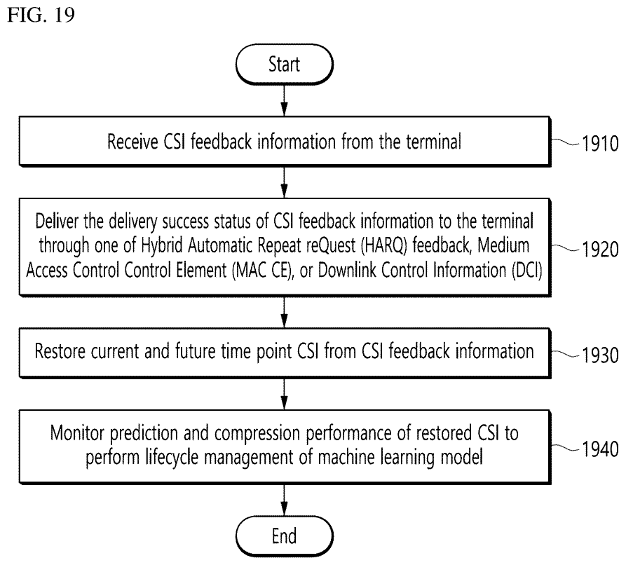

FIG. 19 illustrates a method of operation of a base station according to an embodiment of the present disclosure.

Referring to FIG. 19, the base station first receives CSI feedback information from a terminal (1910). According to one embodiment, the received CSI feedback information can include prediction information for target CSI(s) at current and future time instances, and the number of past CSI feedback information or bitmap information can also be received along with the CSI feedback information. The maximum number of past CSI feedback information can be set through a higher layer parameter, maximum number of past CSI feedback (maxNumberOfPastCsiFeedback). Additionally, it can receive a setting for the maximum number of past reconstructed CSI (maxNumberOfPastOutputCsi) from the terminal, through which it can substitute for or use together with past CSI feedback information for past reconstructed CSI.

The time instance information of target CSI(s) includes first target CSI time instance (firstTargetCsiTime), target CSI repetition count (numTargetCsi), and target CSI time interval (targetCsiInterval) information, which can be configured to the terminal through higher layer signaling or reported from the terminal. Also, the type of input CSI can be configured as information of the terminal-side machine learning model or through higher layer settings.

Next, the base station can deliver the delivery success status of CSI feedback information to the terminal through one of Hybrid Automatic Repeat reQuest (HARQ) feedback, Medium Access Control Control Element (MAC CE), or Downlink Control Information (DCI) (1920). According to one embodiment, if the terminal utilizes past CSI feedback information, it can explicitly allocate or implicitly designate a HARQ process for CSI feedback transmission, and can transmit both ACK/NACK or transmit HARQ feedback only when a NACK occurs.

Then the base station can restore CSI for current and future time instances from the CSI feedback information (1930). In the reconstruction process, it can determine which past CSI feedback information to utilize based on the received number of past CSI feedback information or bitmap information. The reconstructed output CSI for each target time instance can be delivered back to the terminal, which can be done by directly delivering without compression or using an existing CSI feedback method. When using the existing CSI feedback method, it can use a high CSI parameter combination (paramCombination) defined in the specification or a parameter larger than the largest CSI parameter combination defined in the specification.

Finally, the base station can monitor the prediction and compression performance of the reconstructed CSI to perform lifecycle management of the machine learning model (1940). For this, it can transmit CSI-RS for performance monitoring to the terminal and evaluate prediction performance by receiving the actual CSI at the target CSI time instance from the terminal. It can also receive CSI prediction and compression performance monitoring results from the terminal. Based on these monitoring results, it can perform lifecycle management such as model activation, deactivation, updates, model changes, or fallback operations.

The base station can confirm the availability of past CSI feedback information utilization through the terminal's capability information and can also receive the length information of the CSI feedback message transmitted by the terminal. At this time, the CSI feedback length can be set differently depending on whether past reconstructed CSI is utilized, and if the length is selected according to clear rules, the separate transmission of length information can be omitted.

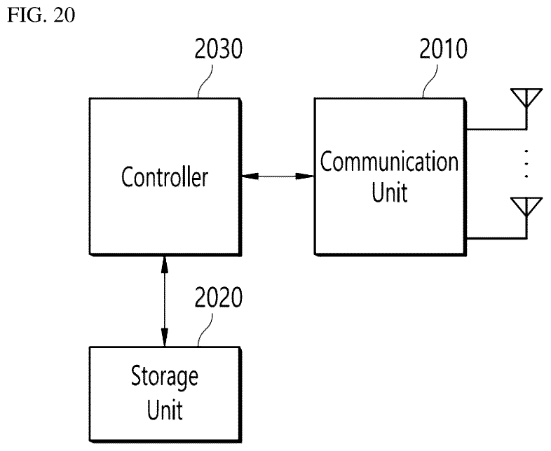

FIG. 20 illustrates a configuration of a base station in a wireless communication system according to various embodiments of the present disclosure. The configuration exemplified in FIG. 20 can be understood as a configuration of a base station. Terms such as “ . . . unit”, “ . . . device”, etc. used below mean a unit that processes at least one function or operation, and can be implemented by hardware, software, or a combination of hardware and software.

Referring to FIG. 20, the base station can include a wireless communication unit (2010), a backhaul communication unit (2020), a storage unit (2030), and a controller (2040).

The wireless communication unit (2010) can transmit and receive wireless signals through wireless channels. For example, the wireless communication unit (2010) can perform conversion functions between baseband signals and bit sequences according to the physical layer specifications of the system. Also, when transmitting data, the wireless communication unit (2010) can generate complex symbols by encoding and modulating the transmission bit sequence. When receiving data, the wireless communication unit (2010) can restore the reception bit sequence through demodulation and decoding of the baseband signal.

The wireless communication unit (2010) can up-convert baseband signals to RF (radio frequency) band signals and transmit them through antennas, and down-convert RF band signals received through antennas to baseband signals. For this, the wireless communication unit (2010) can include transmission filters, reception filters, amplifiers, mixers, oscillators, DACs (digital to analog converters), and ADCs (analog to digital converters).

The wireless communication unit (2010) can include multiple transmission and reception paths, and the wireless communication unit (2010) can include at least one antenna array composed of multiple antenna elements.

From a hardware perspective, the wireless communication unit (2010) can include a digital unit and an analog unit, and the analog unit can include multiple sub-units depending on operating power, operating frequency, etc. The digital unit can be implemented with at least one processor (e.g., DSP (digital signal processor)).

The wireless communication unit (2010) can transmit and receive wireless signals as described above. Accordingly, all or part of the wireless communication unit (2010) can be referred to as a “transmitter”, “receiver”, or “transceiver”. Also, in the following description, transmission and reception through wireless channels can include the processing described above by the wireless communication unit (2010).

The backhaul communication unit (2020) can provide an interface for communicating with other nodes in the network. That is, the backhaul communication unit (2020) can convert bit sequences transmitted from the base station to other nodes, such as other access nodes, other base stations, higher nodes, and core networks, into physical signals, and convert physical signals received from other nodes into bit sequences.

The storage unit (2030) can store basic programs, application programs, setting information, and other data for the operation of the base station. The storage unit (2030) can be composed of volatile memory, non-volatile memory, or a combination of volatile and non-volatile memory. And, the storage unit (2030) can provide stored data according to the request of the controller (2040).

The controller (2040) can control the overall operations of the base station. For example, the controller (2040) can transmit and receive signals through the wireless communication unit (2010) or the backhaul communication unit (2020). Also, the controller (2040) can write and read data to and from the storage unit (2030). The controller (2040) can perform functions of the protocol stack required by communication standards.

For this, the controller (2040) can include at least one processor.

According to various embodiments of the present disclosure, the controller (2040) can control to perform various operations according to the embodiments performed by the base station as described above.

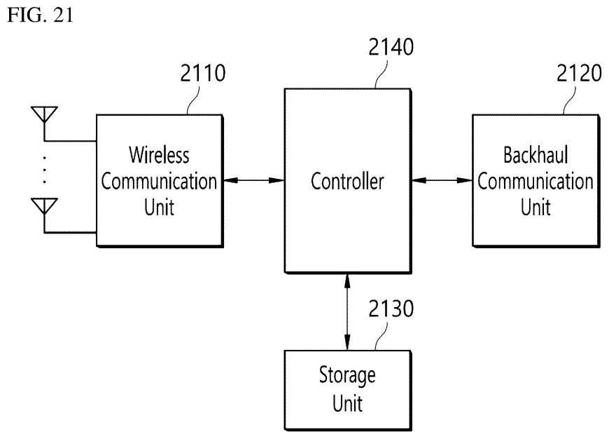

FIG. 21 illustrates a configuration of a terminal in a wireless communication system according to various embodiments of the present disclosure. The configuration exemplified in FIG. 21 can be understood as a configuration of a terminal. Terms such as “ . . . unit”, “ . . . device”, etc. used below mean a unit that processes at least one function or operation, and can be implemented by hardware, software, or a combination of hardware and software.

Referring to FIG. 21, the terminal can include a communication unit (2110), a storage unit (2120), and a controller (2130).

The communication unit (2110) can perform functions for transmitting and receiving signals through wireless channels. For example, the communication unit (2110) can perform conversion functions between baseband signals and bit sequences according to the physical layer specifications of the system. For example, when transmitting data, the communication unit (2110) can generate complex symbols by encoding and modulating the transmission bit sequence. When receiving data, the communication unit (2110) can restore the reception bit sequence through demodulation and decoding of the baseband signal. Also, the communication unit (2110) can up-convert baseband signals to RF band signals and transmit them through antennas, and down-convert RF band signals received through antennas to baseband signals. For example, the communication unit (2110) can include transmission filters, reception filters, amplifiers, mixers, oscillators, DACs, ADCs, etc.

Also, the communication unit (2110) can include multiple transmission and reception paths. Furthermore, the communication unit (2110) can include at least one antenna array composed of multiple antenna elements. From a hardware perspective, the communication unit (2110) can be composed of digital circuits and analog circuits (e.g., RFIC (radio frequency integrated circuit)). Here, the digital circuits and analog circuits can be implemented as one package. Also, the communication unit (2110) can include multiple RF chains. Furthermore, the communication unit (2110) can perform beamforming.

The communication unit (2110) transmits and receives signals as described above. Accordingly, all or part of the communication unit (2110) can be referred to as a “transmitter”, “receiver”, or “transceiver”. Also, in the following description, transmission and reception through wireless channels can be used to include the processing as described above by the communication unit (2110).

The storage unit (2120) can store basic programs, application programs, setting information, and other data for the operation of the terminal. The storage unit (2120) can be composed of volatile memory, non-volatile memory, or a combination of volatile and non-volatile memory. And, the storage unit (2120) can provide stored data according to the request of the controller (2130).

The controller (2130) can control the overall operations of the terminal. For example, the controller (2130) can transmit and receive signals through the communication unit (2110). Also, the controller (2130) can write and read data to and from the storage unit (2120). The controller (2130) can perform functions of the protocol stack required by communication standards. For this, the controller (2130) can include at least one processor or micro processor, or it can be part of a processor. Also, part of the communication unit (2110) and the controller (2130) can be referred to as a CP (communication processor).

According to various embodiments, the controller (2130) can control to perform various operations according to the embodiments performed by the terminal as described above.

Terms used to refer to signals, channels, control information, network entities, components of devices, etc. in the following description are examples for convenience of explanation. Therefore, the present disclosure is not limited to the terms described below, and other terms with equivalent technical meaning may be used.

Also, although the present disclosure describes various embodiments using terms used in certain communication standards (e.g., 3GPP (3rd Generation Partnership Project)), this is just an example for explanation. The various embodiments of the present disclosure can be readily modified and applied to other communication systems.

Methods according to embodiments described in the claims or specification of the present disclosure can be implemented in the form of hardware, software, or a combination of hardware and software.

When implemented in software, one or more programs (software modules) can be provided in a computer-readable storage medium. One or more programs stored in the computer-readable storage medium are configured for execution by one or more processors within an electronic device. One or more programs include instructions for causing the electronic device to perform the methods according to the embodiments described in the claims or specification of the present disclosure.

Such programs (software modules, software) can be stored in random access memory, non-volatile memory including flash memory, read only memory (ROM), electrically erasable programmable read only memory (EEPROM), magnetic disc storage devices, compact disc-ROM (CD-ROM), digital versatile discs (DVDs) or other forms of optical storage devices, magnetic cassettes. Or, they can be stored in memory consisting of a combination of some or all of these. Also, each component memory can include multiple instances.

Also, programs can be stored in attachable storage devices that can be accessed through communication networks such as the Internet, Intranet, LAN (local area network), WAN (wide area network), or SAN (storage area network), or a combination of these. Such storage devices can connect to the device performing the embodiments of the present disclosure through an external port. Also, separate storage devices on the communication network can connect to the device performing the embodiments of the present disclosure.

In the specific embodiments of the present disclosure described above, components included in the disclosure were expressed as singular or plural according to the presented specific embodiments. However, the expression of singular or plural is chosen appropriately for the situation presented for convenience of description, and the present disclosure is not limited to components of singular or plural, and plural expressed components can be composed as singular, or singular expressed components can be composed as plural.

Meanwhile, although specific embodiments have been described in the detailed description of the present disclosure, various modifications are possible within the limits that do not deviate from the scope of the present disclosure. Therefore, the scope of the present disclosure should not be limited to the described embodiments but should be determined by the following patent claims and their equivalents.

What is claimed is:

1. A method performed by a terminal for feeding back channel state information (CSI) in a wireless communication system, the method comprising:
acquiring CSI for at least one past time instance and a current time instance, or only for the current time instance;
deriving input CSI based on CSI for at least one past time instance or the current time instance, or only for the current time instance;
generating CSI feedback information by using the input CSI as input to a machine learning model; and
transmitting the generated CSI feedback information to a base station,
wherein the CSI feedback information includes information for reconstructing at least one target CSI, and
wherein the at least one target CSI includes CSI at a current time instance, or one or more future time instances.

2. The method of claim 1, further comprising:
receiving, from the base station, a delivery success status of the CSI feedback information; and
when the delivery fails, not utilizing the failed past CSI feedback information when generating subsequent CSI feedback information.

3. The method of claim 2, wherein the not utilizing comprises:
transmitting by setting a number of past CSI feedback information related to the CSI feedback information to 0, or by setting a bit position of the failed CSI feedback in a bitmap indicating utilization of past CSI feedback information to 0.

4. The method of claim 1, wherein the at least one target CSI includes CSI at one or more future time instances, and the input CSI includes the same as the acquired CSI for at least one past time instance, the current time instance, or only the current time instance, the method further comprising:
receiving reference signal (RS) for performance monitoring from the base station;
measuring actual channel state for at least one future time instance through the RS; and
delivering the measured channel state to the base station.

5. The method of claim 1, wherein the at least one target CSI includes CSI at one or more future time instances, and the input CSI includes the same as the acquired CSI for at least one past time instance, the current time instance, or only the current time instance, the method further comprising:
receiving reconstructed CSI for one or more future time instances from the base station and
receiving reference signal (RS) for performance monitoring;
measuring actual channel state for one or more future time instances through the RS;
deriving performance monitoring results using the received reconstructed CSI for one or more future time instances and the measured actual channel state; and
delivering the derived performance monitoring results to the base station.

6. The method of claim 1, wherein the at least one target CSI includes CSI at one or more future time instances, and the input CSI includes CSI at least one future time instance derived by applying a prediction method that can be configured separately, the method further comprising:
delivering the input CSI to the base station.

7. The method of claim 1, wherein the at least one target CSI includes CSI at one or more future time instances, and the input CSI includes CSI at one or more future time instances derived by applying a prediction method that can be configured separately, the method further comprising:
receiving reconstructed CSI for one or more future time instances from the base station;
deriving performance monitoring results using the received reconstructed CSI for one or more future time instances and the input CSI; and
delivering the derived performance monitoring results to the base station.

8. The method of claim 1, wherein the at least one target CSI includes CSI at one or more future time instances, and the input CSI includes CSI at one or more future time instances derived by applying a prediction method that can be configured separately, the method further comprising:
receiving reference signals for performance monitoring from the base station;
measuring actual channel state for one or more future time instances through the reference signals; and
delivering the measured actual channel state to the base station.

9. The method of claim 1, wherein the at least one target CSI includes CSI at one or more future time instances, and the input CSI includes CSI at one or more future time instances derived by applying a prediction method that can be configured separately, the method further comprising:
receiving reconstructed CSI for one or more future time instances from the base station and receiving reference signals for performance monitoring;
measuring actual channel state for one or more future time instances through the reference signals;
deriving performance monitoring results using the received reconstructed CSI for one or more future time instances and the measured actual channel state; and
delivering the derived performance monitoring results to the base station.

10. The method of claim 1, further comprising:
receiving two or more CSI feedback lengths from the base station, and when there is no past CSI information, performing feedback using a longer feedback length among the two or more CSI feedback lengths.

11. A method of operating a base station for receiving channel state information (CSI) in a wireless communication system, the method comprising:
receiving CSI feedback information from a terminal;
restoring current and at least one future time instance's CSI from the CSI feedback information; and
monitoring prediction and compression performance of the reconstructed CSI to perform lifecycle management of a machine learning model,
wherein the CSI feedback information is generated by using input CSI derived based on CSI for at least one past time instance and CSI for at least one current time instance at the terminal as input to a machine learning model.

12. The method of claim 11, further comprising:
delivering a reception success status of the CSI feedback information to the terminal based on at least one of Hybrid Automatic Repeat reQuest (HARQ) feedback, Medium Access Control Control Element (MAC CE), or Downlink Control Information (DCI).

13. The method of claim 11, further comprising:
transmitting channel state information reference signals for performance monitoring to the terminal; and
evaluating prediction performance by receiving CSI measured at target CSI time instances from the terminal.

14. The method of claim 11, wherein the lifecycle management includes at least one of model activation, deactivation, updates, model changes, or fallback operations.

15. The method of claim 11, further comprising:
delivering the reconstructed CSI to the terminal; and
receiving CSI prediction and compression performance monitoring results from the terminal.

16. The method of claim 11, further comprising:
determining past CSI feedback information to be utilized in CSI reconstruction based on at least one of a number of past CSI feedback information or bitmap information received together with the CSI feedback information.

17. A terminal for feeding back channel state information (CSI) in a wireless communication system, the terminal comprising:
a transceiver; and
a controller operably connected to the transceiver, wherein the controller is configured to:
acquire CSI based on CSI for at least one past time instance or a current time instance, or only for the current time instance;
derive input CSI based on CSI for at least one past time instance or the current time instance, or only for the current time instance;
generate CSI feedback information by using the input CSI as input to a machine learning model; and
control the transmission of the generated CSI feedback information to a base station,
wherein the CSI feedback information includes information for reconstructing at least one target CSI, and
wherein the at least one target CSI include CSI at a current time instance, or one or more future time instances.

18. The terminal of claim 17, wherein the controller is further configured to:
receive a delivery success status of the CSI feedback information from the base station; and
when the delivery fails, not utilize the failed past CSI feedback information when generating subsequent CSI feedback information.
